(19) United States
(12) Patent Application Publication
(10) Pub. No.: US 2007/0146482 A1
(43) Pub. Date: Jun. 28, 2007

(54) Method of depth estimation from a single camera

(76) Inventor: Branislav Kiscanin, Kokomo, IN (US)

Correspondence Address: DELPHI TECHNOLOGIES, INC., M/C 480-410-202, PO BOX 5052, TROY, MI, 48007, US

(21) Appl. No.: 11/318,294

(22) Filed: Dec. 23, 2005

(51) Int. Cl. H04N 7/18

(52) U.S. Cl. 348/148

(57) ABSTRACT

The invention relates to an occupant monitoring system for an automobile. One embodiment of the invention includes a monitoring system configured to detect an occupant's head position when the occupant is seated in the automobile.

### TECHNICAL BACKGROUND

The invention relates to an occupant monitoring system for an automobile.

### BACKGROUND OF THE INVENTION

Monitoring the position of occupants in a vehicle has become a valuable tool for improving automobile safety. Information such as occupant seating position and head position may be used with other vehicle safety features such as the vehicle airbag to reduce the chance of injury during an accident. Currently, multiple cameras are positioned within the passenger compartment of the vehicle to monitor the occupants. Data gathered from the images captured by the cameras is continuously analyzed to track occupant position and movement.

### SUMMARY OF THE INVENTION

One embodiment of the present invention includes an occupant monitoring system for monitoring a position of an occupant's head in an automobile, the system comprising at least one light source positioned to provide light to illuminate a portion of the passenger's head, a camera spaced apart from the light source, the camera being positioned to capture an image of the light illuminating the occupant's head and output a signal corresponding to the image, and a processor configured to receive the signal and determine the position of the occupant's head relative to the camera based on the illuminated portion of the occupant's head in the image.

Another embodiment of the present invention includes a method of determining the position of an occupant's head in an automobile, the method including the steps of providing at least one light source, a camera, and a processor, actuating the light source to illuminate a portion of the occupant's head, actuating the camera to capture an image including the occupant's head and the illuminated portion of the occupant's head and output a signal corresponding to the image, determining the position of the occupant's head relative to the camera based on a position of the illuminated portion of the occupant's head in the image.

Another embodiment of the present invention includes a driver monitoring system for an automobile for determining a head position of the driver of the automobile, the monitoring system including an illuminator positioned to illuminate a portion of the driver's head, a camera spaced apart from the illuminator, the camera positioned to capture an image of the driver's head and the illuminated portion of the driver's head, the image including a vertical axis and a horizontal axis, and a processor configured to analyze the image and determine a distance of the driver's head from the camera by determining a measurement along the vertical axis of the illuminated portion of the driver's head in the image and inputting it into an empirically determined equation.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a diagram illustrating the components of one embodiment of an occupant monitoring system;

FIG. 2 is an example of an image captured by a camera of the occupant monitoring system;

FIG. 3 is an example of another image captured by a camera of the occupant monitoring system;

FIG. 4 is an example of another image captured by a camera of the occupant monitoring system;

FIG. 5 is an example of another image captured by a camera of the occupant monitoring system;

FIG. 6 is an example of another image captured by a camera of the occupant monitoring system;

FIG. 7 is an example of another image captured by a camera of the occupant monitoring system;

FIG. 8 is an example of another image captured by a camera of the occupant monitoring system; and

FIG. 9 is a chart comparing the true distance of the occupant from the camera with a calculated distance of the occupant from the camera.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DESCRIPTION OF INVENTION

The embodiments discussed below are not intended to be exhaustive or limit the invention to the precise forms disclosed in the following detailed description. Rather, the embodiments are chosen and described so that others skilled in the art may utilize their teachings.

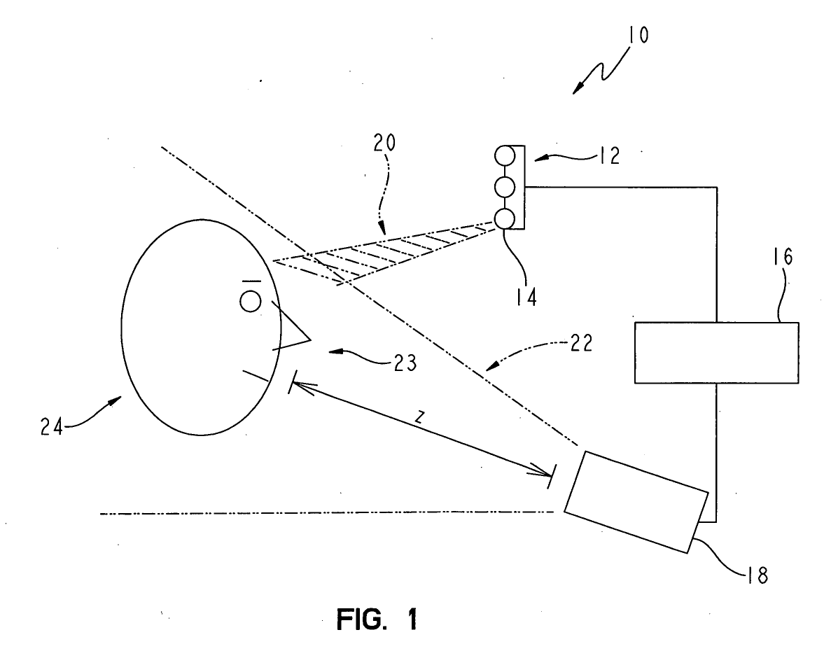

An occupant monitoring system 10 for determining the position of an occupant's head 24 in an automobile is shown in FIG. 1. Occupant monitoring system 10 includes camera 18, light source 12, and processor 16. In this embodiment, occupant monitoring system 10 determines the distance Z between the occupant's face 23 and camera 18. As discussed above, distance Z may be used along with a variety of other measurements to determine characteristics such as the location and position of occupant's head 24. In other embodiments, occupant monitoring system 10 may be used to determine the position of the torso of the occupant or any other suitable object. In this exemplary embodiment, system 10 is positioned on the driver's side of the automobile and is configured to monitor the position of the driver's head.

In this embodiment, light source 12 includes an emitter 14. Emitter 14 of light source 12 emits a band of light 20 that is projected onto face 23 of occupant's head 24. Light source 12 may include a bank of infrared (IR) light emitting diodes (LEDs), a laser diode, or any other suitable light source. In this embodiment, emitter 14 emits light 20 in only a single plane, or close to it, defined by a point and a line. The point is the location of emitter 14 and the line is a horizontal line parallel to the left-right direction in the automobile at an elevation such that the line passes thru the center of face 23 of occupant's head 24 when occupant's head 24 is positioned in the nominal position. The nominal head position is defined by the head location of an average-height driver in a standard car-driving pose, looking forward, head close to or against the head rest. The narrow band of light 20 may be produced by providing an opaque mask (not shown) positioned on emitter 14.

Camera 18 periodically captures an image of face 23 of occupant's head 24 and provides a signal corresponding to the image to processor 16. Camera 18 may include an IR camera, a laser-detecting camera, or any other camera configured to capture light emitted from light source 12. In this embodiment, camera 18 captures images of objects positioned in field of view 22 projected from camera 18.

In this embodiment, processor 16 is coupled to both camera 18 and light source 12. Processor 16 controls emitter 14 and camera 18 to determine distance Z. In operation, processor 16 actuates emitter 14 to project band of light 20 onto face 23 of occupant's head 24. At the same time, processor 16 actuates camera 18 to capture and image of face 23 which is illuminated by band of light 20. The image is then sent from camera 18 to processor 16. Processor 16 may be programmed to capture an image periodically such as every one-third of second. Processor 16 then determines distance Z using the methods described below and outputs this data to other systems on the automobile and/or performs other calculations using the data.

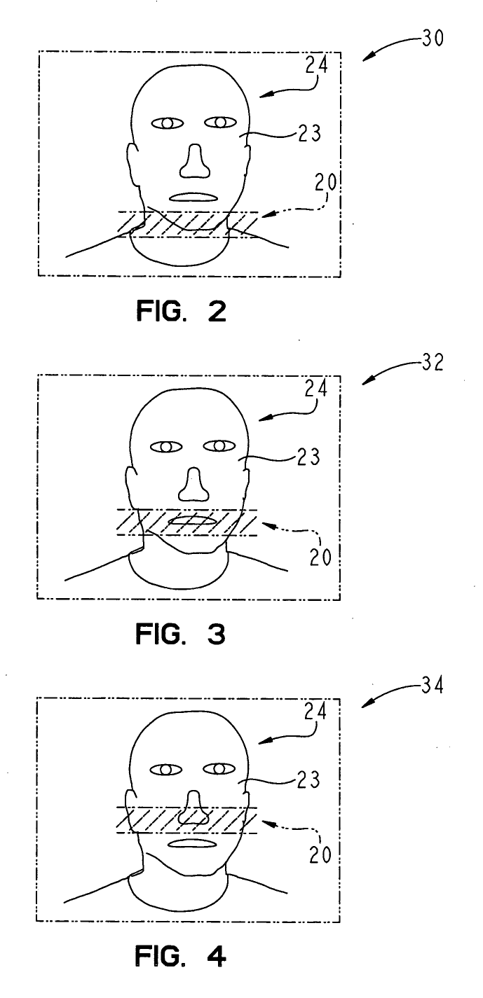

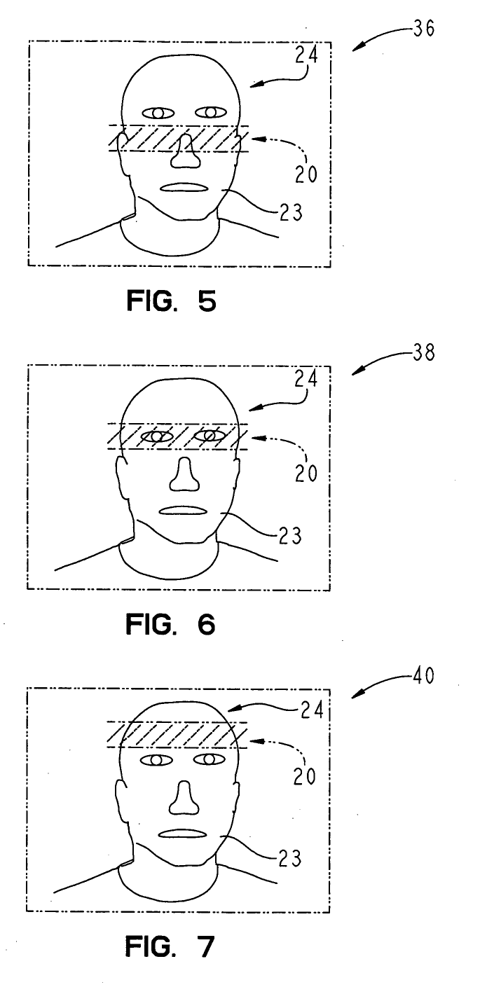

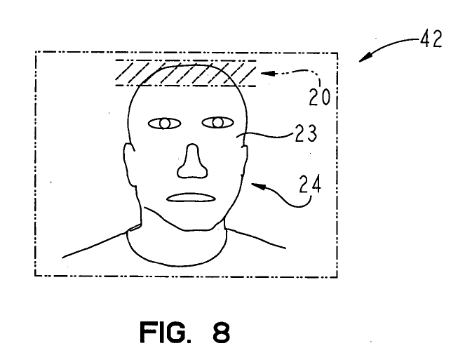

Examples of images captured by camera 18 are shown in FIGS. 2-8. In image 30, shown in FIG. 2, the majority of the image includes face 23 of occupant's head 24. Band of light 20 is shown as the shaded area, however in the actual image, band of light 20 may be a brightened or illuminated area. In image 30, band of light 20 illuminates a chin area of face 23 and appears in a lower portion of image 30. As shown in images 32, 34, 36, 38, 40, and 42 in FIGS. 3-8, the shaded area corresponding to band of light 20 appears at progressively higher positions in the aforementioned images. Processor 16 determines distance Z between face 23 of occupant's head 24 and camera 18 by measuring the vertical height or distance of the appearance of band of light 20 in images captured by camera 18. For example, when occupant's head 24 is present in the image such as images 30 and 42, the appearance of band of light 20 appears higher such as image 42 or lower such as image 30, depending on distance Z between face 23 of occupant's head 24 and camera 18. The higher the appearance of light band 20 in the image indicates a smaller distance Z. An angle (not shown) between band or plane of light 20 (in FIG. 1) and the central axis of field of view 22 of camera 18 translates changes in distance Z into changes of the vertical position of the appearance of band of light 20 (in FIG. 2) in the images captured by camera 18. In this embodiment the angle between the band of light 20 and the central axis of field of view 22 of camera 18 is generally greater than 10 degrees.

To determine the vertical distance of the appearance of the band of light 20 in the images captured by camera 18, imaging such as binarizing the images and determining the center of mass of bright area corresponding to band of light 20 in the image may be used by processor 16. The center of mass of the bright area of each image is positioned at a distance of Y pixels from the upper or lower edge of the image. A linear model such as Equation 1, shown below, may be used by processor 16 to relate distance Z and vertical pixel distance Y.
Z=K*Y+N (Eq. 1)
The constants K and N may be determined from the physical dimensions of the automobile and occupant monitoring system 10 or by conducting experimental testing in which distance Z is measured for several different values of Y. The experiment data may then be input into the classical Least Squares method to determine constants K and N or used to create a look up table. Examples of other models that may be used to determine constants K and N include using a piecewise linear model and applying classical Least Squares to each piece and Nonlinear Least Squares.

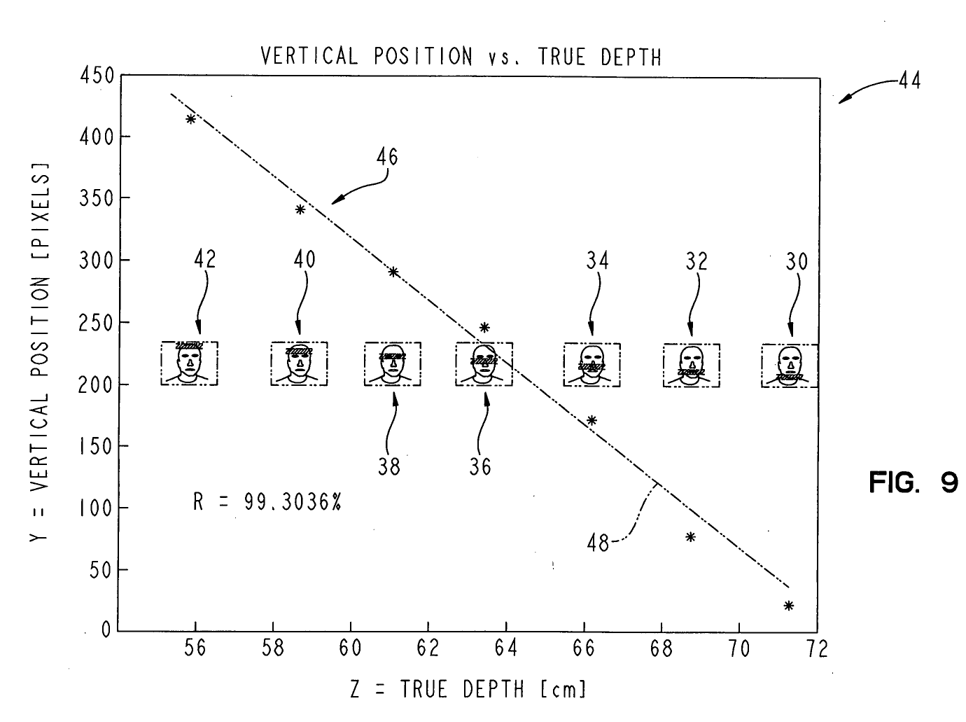

FIG. 9 includes chart 44 depicting experimental data from testing in which distance Z was measured for seven different values of Y. Chart 44 illustrates the vertical pixel position or distance Y on the y-axis and the true depth or measured distance Z between camera 18 and face 23 of occupant's head 24 in centimeters. Data set 46 includes an illustration of the corresponding images 42, 40, 38, 36, 34, 32, and 30, discussed above, indicating the vertical position of the appearance of band of light 20 in the respective images. Trend line 48 was determined for data set 46 having a relatively high R value (99.3036%) indicating that relationship between Y and Z is relatively linear. Constants K and N may be calculated using the equation corresponding to trend line 48 as an empirical correlation.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An occupant monitoring system for monitoring a position of an occupant's head in an automobile, the system comprising:
at least one light source positioned to provide light to illuminate a portion of the passenger's head;
a camera spaced apart from the light source, the camera being positioned to capture an image of the light illuminating the occupant's head and output a signal corresponding to the image; and
a processor configured to receive the signal and determine the position of the occupant's head relative to the camera based on the illuminated portion of the occupant's head in the image.

2. The occupant monitoring system of claim 1, wherein the at least one light source is an infrared light emitting diode (LED).

3. The occupant monitoring system of claim 1, wherein the at least one light source is a laser diode.

4. The occupant monitoring system of claim 1, wherein the light produced by the light source is defined by a horizontal line projected across an occupant's face.

5. The occupant monitoring system of claim 1, wherein the processor determines the distance of the occupant's head from the camera by determining a vertical position of the illuminated portion of the occupant's head in the image and comparing it to one of an empirical correlation, experimental data, and a look-up table.

6. The occupant monitoring system of claim 1, wherein automobile includes a driver's side and a passenger side, the occupant monitor system being positioned on the driver's side of the automobile and configured to monitor the position of a driver's head.

7. The occupant monitoring system of claim 1, wherein the camera is positioned along a first axis and the light source is positioned along a second axis, the first axis positioned at angle equal to at least 10 degrees relative to the second axis.

8. The occupant monitoring system of claim 1, wherein the image includes a vertical axis and a transverse axis, the processor being configured to analyze the image and determine a position on the vertical axis corresponding to the illuminated portion of the occupant's head.

9. The occupant monitoring system of claim 1, wherein the processor is configured to determine a distance between the camera and the occupant's head.

10. A method of determining the position of an occupant's head in an automobile, the method including the steps of:
providing at least one light source, a camera, and a processor;
actuating the light source to illuminate a portion of the occupant's head;
actuating the camera to capture an image including the occupant's head and the illuminated portion of the occupant's head and output a signal corresponding to the image;
determining the position of the occupant's head relative to the camera based on a position of the illuminated portion of the occupant's head in the image.

11. The method of claim 10, wherein the at least one light source is one of an infrared light emitting diode and a laser diode.

12. The method of claim 10, wherein the at least one light source and the camera are controlled by the processor.

13. The method of claim 10, wherein the at least one light source is configured to project a horizontally extending band of light onto the occupant's head.

14. The method of claim 10, wherein the processor determines the distance of the occupant's head from the camera.

15. The method of claim 10, wherein the steps of actuating the light source, actuating the camera, and determining the position of the occupant's head relative to the camera are repeated in a predetermined time period.

16. The method of claim 15, wherein the predetermined time period is less than one second.

17. The method of claim 10, further comprising the step of adjusting the deployment of an airbag positioned adjacent to the occupant based on the position of the occupant's head determined in the previous step.

18. A driver monitoring system for an automobile for determining a head position of a driver of the automobile, the monitoring system including:
an illuminator positioned to illuminate a portion of the driver's head;
a camera spaced apart from the illuminator, the camera positioned to capture an image of the driver's head and the illuminated portion of the driver's head, the image including a vertical axis and a horizontal axis; and
a processor configured to analyze the image and determine a distance of the driver's head from the camera by determining a measurement along the vertical axis of the illuminated portion of the driver's head in the image and inputting it into an empirically determined equation.

19. The driver monitoring system of claim 18, wherein the illuminator is one of an infrared light emitting diode and a laser diode.

20. The driver monitoring system of claim 18, wherein the monitoring system is configured to determine the driver's head position at least once per second.
